(19) United States
(12) Patent Application Publication
(10) Pub. No.: US 2006/0030487 A1
(43) Pub. Date: Feb. 9, 2006

(54) Materials and methods for the regeneration of plants from cultured plant tissue

(76) Inventors: Jhy-Jhu Lin, Potomac, MD (US); Nacyra Assad-Garcia, Gaithersburg, MD (US)

Correspondence Address: GREENLEE WINNER AND SULLIVAN P C, 4875 PEARL EAST CIRCLE, SUITE 200, BOULDER, CO, 80301, US

(21) Appl. No.: 11/238,903

(22) Filed: Sep. 28, 2005

Related U.S. Application Data
(63) Continuation of application No. 10/884,650, filed on Jul. 2, 2004, now abandoned.
Application No. 10/884,650 is a continuation of application No. 09/805,383, filed on Mar. 12, 2001, now abandoned.
Application No. 10/884,650 is a continuation of application No. 10/747,589, filed on Dec. 29, 2003, now abandoned.
Application No. 10/747,589 is a continuation of application No. 10/192,241, filed on Jul. 9, 2002, now abandoned.
Application No. 10/192,241 is a continuation of application No. 09/923,892, filed on Aug. 7, 2001, now Pat. No. 6,610,544.
Application No. 09/923,892 is a continuation of application No. 09/392,177, filed on Sep. 9, 1999, now Pat. No. 6,271,032.
Application No. 09/392,177 is a continuation of application No. 08/861,666, filed on May 22, 1997, now Pat. No. 5,994,135.
Application No. 08/861,666 is a continuation of application No. 08/430,209, filed on Apr. 27, 1995, now Pat. No. 5,674,731.
(60) Provisional application No. 60/188,268, filed on Mar. 10, 2000.

(51) Int. Cl. A01N 43/36; A01N 43/54

(52) U.S. Cl. 504/138; 504/240

(57) ABSTRACT

The present invention provides compositions and methods for affecting plant growth. In addition the present invention provides a medium for the production of an embryogenic callus from a plant sample and a medium for the regeneration of a plant sample. The present invention also contemplates kits for the culture plant samples and the regeneration of plant samples.

### CROSS-REFERENCE TO RELATED APPLICATIONS

This application is a continuation of U.S. patent application Ser. No. 10/884,650, filed Jul. 2, 2004, which is a continuation of U.S. patent application Ser. No. 09/805,383, filed Mar. 12, 2001, which takes priority under 35 U.S.C. 119(e) from U.S. provisional application Ser. No. 60/188,268, filed Mar. 10, 2000; and a continuation of U.S. patent application Ser. No. 10/747,589, filed Dec. 29, 2003, which is a continuation U.S. patent application Ser. No. 10/192,241, filed Jul. 9, 2002, which is a continuation of U.S. patent application Ser. No. 09/923,892, filed Aug. 7, 2001 (now U.S. Pat. No. 6,610,544, issued Aug. 26, 2003), which is a continuation of U.S. patent application Ser. No. 09/392,177, filed Sep. 9, 1999 (now U.S. Pat. No. 6,271,032, issued Aug. 7, 2001), which is a continuation of U.S. patent application Ser. No. 08/861,666, filed May 22, 1997 (now U.S. Pat. No. 5,994,135, issued Nov. 30, 1999), which is a continuation of U.S. patent application Ser. No. 08/430,209, filed Apr. 27, 1995 (now U.S. Pat. No. 5,674,731, issued Oct. 7, 1997), all of which are incorporated by reference in their entirety herein.

### BACKGROUND OF THE INVENTION

The present invention relates to the field of agricultural biotechnology. In particular, the present invention provides compositions and methods for affecting plant growth and regenerating plants from plant tissue or transformed plant tissue.

Plant growth is affected by a variety of physical and chemical factors. Physical factors include available light, day length, moisture and temperature. Chemical factors include minerals, nitrates, cofactors, nutrient substances and plant growth regulators or hormones, for example, auxins, cytokinins and gibberellins.

Indole-3-acetic acid (IAA) is a naturally-occurring plant growth hormone identified in plants. IAA has been shown to be directly responsible for increase in growth in plants in vivo and in vitro. The characteristics influenced by IAA include cell elongation, internodal distance (height), leaf surface area and crop yield. IAA and other compounds exhibiting hormonal regulatory activity similar to that of IAA are included in a class of plant regulators called “auxins.”

Compounds known to function as auxins in plants include, for example, 4-chloroindole-3-acetic acid (4-CI-IAA) which is a naturally occurring plant growth regulator, acting to induce stem elongation and to promote root formation. Whereas IAA is found in most organs of a plant, 4-CI-IAA was shown to be present in immature and mature seeds of Pisum sativum, but not in any other organ (Ulvskov, et al., (1992) 188:182-189). Some synthetic auxins include naphthalene-1-acetic acid (NAA), 5,6-dichloro-indole-3-acetic acid (5,6-Cl₂-IAA), 4-chloro-2-methylphenoxyacetic acid (MCPA); 2,4-dichlorophenoxyacetic acid (2,4D); 2,4,5-trichlorophenoxyacetic acid (2,4,5-T); 2-(4-chloro-2-methylphenoxy)propionic acid (CMPP); 4-(2,4-dichlorophenoxy)butyric acid (2,4-DB); 2,4,5-trichlorobenzoic acid (TBA); and 3,5-dichloro-2-methoxybenzoic acid (dicamba), for example. All the above acids are active in the form of their salts and esters, such as their sodium, potassium, ammonium, dimethylamine and ethanolamine salts, and their lower alkyl esters. Many of these synthetic auxins are being used commercially as effective herbicides and some of them are known to adversely affect morphogenesis of treated plants.

Preparations based on cytokinins, such as 6-furfurylamino purine (kinetin) and 6-benzylamino purine (BAP), are also known to be growth stimulators. However, cytokinin-based preparations are most effective in combination with auxins. While the mechanism by which cytokinins affect the growth cycle of plants is far from being understood, it is apparent that they affect leaf growth and prevent aging in certain plants.

It is a general objective in the field to successfully regenerate plants of major crop varieties using methods such as tissue culture and genetic engineering. The art of plant tissue culture has been an area of active research for many years but over the past five to ten years an intensified scientific effort has been made to develop regenerable plant tissue culture procedures for the important agricultural crops such as maize, wheat, rice, soybeans, and cotton.

In vitro culture techniques are well established in plant breeding (Reinert, J., and Bajaj, Y. P. S., eds. (1977) Plant Cell, Tissue and Organ Culture, Berlin: Springer; Simmonds, N. W. (1979) Principles of Crop Improvement, London: Longman; Vasil, I. K. , Ahuja, M. K. and Vasil, V. (1979) “Plant tissue cultures in genetics and plant breeding,” Adv. Genet. 20:127-215). First, embryo culture has, for decades, been a valuable adjunct to making difficult interspecific crosses. Second, more recent but also well established, is shoot-tip culture, which finds uses in rapid clonal multiplication, development of virus-free clones and genetic resource conservation work. Both techniques depend upon the retention of organizational integrity of the meristem. Another frequently used technique involves the in vitro culturing of plant tissue in which organization is lost but can in most cases be recovered. Examples of this type of technique include callus, cell, and protoplast cultures. An application of cultured cells has been in vitro hybridization, which has, after regeneration, yielded interspecific amphidiploids. The technique may provide desired amphidiploids which cannot be made by conventional means, and presents possibilities for somatic recombination by some variant of it. The foregoing techniques are widely in use (Chaleff, R. S. (1981) Genetics of Higher Plants, Applications of Cell Culture, Cambridge: Cambridge University Press).

Plant genetic engineering techniques enable the following steps: (a) identification of a specific gene; (b) isolation and cloning of the gene; (c) transfer of the gene to recipient plant host cells: (d) integration, transcription and translation of the DNA in the recipient cells; and (e) multiplication and use of the transgenic plant (T. Kosuge, C. P. Meredith and A. Hollaender, eds (1983) Genetic Engineering of Plants, 26:5-25; Rogers et al., (1988) Methods for Plant Molecular Biology, A. Weissbach and H. Weissbach, eds., Academic Press, Inc., San Diego, Calif.). Newly inserted foreign genes have been shown to be stably maintained during plant regeneration and are transmitted to progeny as typical Mendelian traits (Horsch, et al. (1984) Science 223:496, and DeBlock, et al., (1984) EMBO 3:1681). The foreign genes retain their normal tissue specific and developmental expression patterns.

Successful transformation and regeneration techniques have been demonstrated in the prior art for many plant species and these methods have been used to genetically engineer various plant species. The Agrobacterium tumefaciens-mediated transformation system has proved to be efficient for many dicotyledonous plant species. For example, Barton, et al., (1983, Cell 32:1033) reported the transformation and regeneration of tobacco plants, and Chang, et al., (1994, Planta 5:551-558) described stable genetic transformation of Arabidopsis thaliana.

The Agrobacterium method for gene transfer was also applied to monocotyledonous plants, e. g., in plants in the Liliaceae and Amaryllidaceae families (Hooykaas-Van Slogteren, et al., 1984, Nature 311:763-764) and in Dioscorea bulbifera (yarn) (Schafer, et al., 1987, Nature 327:529-532). In addition, an Agrobacterium based method of transformation has been developed for the important food crops rice (Oryza sativa, see Hiei, et al., Plant Journal, 6:271-282, 1994) and maize (Zea mays, see Ishida, et al., Nature Biotechnology, 14:745-750, 1996).

Transformation of food crops was obtained with alternative methods, e. g., by polyethylene glycol (PEG)-facilitated DNA uptake (Uchimiya, et al., (1986) Mol. Gen. Genet 204:204-207) and electroporation (Fromm, et al., (1986) Nature 319:791-793), both of which used protoplasts as transfer targets. Monocot and dicot tissues may be transformed by bombardment of tissues by DNA-coated particles (Wang, et al., (1988) Plant Mol. Biol. 11:433-439; Wu, in Plant Biotechnology (1989), Kung and Arntzen, Eds. , Butterworth Publishers, Stoneham, Mass.). Regeneration was described in rice (Abdullah, et al., (1986) Bio/Technology 4:1087-1090) and maize (Rhodes, et al., (1988) Bio/Technology 6:56-60 and (1988) Science 240:204-207).

### SUMMARY OF THE INVENTION

A principal object of the present invention is to provide a growth affecting composition comprising one or more indole-3-acetic acid (IAA) derivatives. The compositions of the present invention play a significant role in inducing a number of growth affecting responses in a variety of plant species. Suitable IAA derivatives are described in U.S. patent application Ser. No. 08/758,416 entitled Auxinic Analogues of Indole-3-Acetic Acid, filed Nov. 29, 1996, which is specifically incorporated herein by reference. In some preferred embodiments, the compositions of the present invention may comprise a substituted derivative of IAA. The derivatives of IAA of the present invention may comprise one or more substitutions in the IAA molecule. In some preferred embodiments, the IAA derivative may be a mono-substituted IAA molecule. In some preferred embodiments, the IAA derivative of the present invention may be a di-substituted IAA. In some preferred embodiments, the IAA derivative of the present invention may be a multi-substituted IAA molecule. The derivatives may be in the form of an acid, ester, amide or salt. In some preferred embodiments, the present invention contemplates growth affecting compositions comprising a mono-substituted IAA with a substituent group in the 2, 4, 5, 6, or 7 position of the IAA wherein the substituent may be a halogen, an alkyl group, an alkoxy group , an acyl group, an acylamido group or an acyloxy group having 1-10 carbons. In some preferred embodiments the IAA derivative may be a di-substituted IAA derivative with substituents on two of the 2, 4, 5, 6, or 7 positions of the IAA wherein the substituents may be the same or different and may be a halogen, an alkyl group, an alkoxy group , an acyl group, an acylamido group or an acyloxy group having 1-10 carbons. In some preferred embodiments the IAA derivative may be a multi-substituted IAA derivative with substituents on three or more of the 2, 4, 5, 6, or 7 positions of the IAA wherein the substituents may be the same or different and may be a halogen, an alkyl group, an alkoxy group , an acyl group, an acylamido group or an acyloxy group having 1-10 carbons. In some preferred embodiments, the compositions of the present invention may comprise the IAA derivative 5-bromoindole-3-acetic acid (5-BrIAA) in the form of an acid, ester, amide or salt in an amount sufficient to achieve a plant growth affecting response. The invention contemplates the use of 5-BrIAA to affect growth in both monocotyledonous and dicotyledonous plants.

It is also an object of the invention to provide a composition for affecting plant growth comprising one or more indole-3-acetic acid (IAA) derivatives in a mixture with one or more additional plant growth regulators, for example, an auxin, a cytokinin, a gibberellin, an abscisic acid etc., in definite proportions and concentrations for wide application to various plants in order to achieve a plant growth affecting response. In one aspect, the composition may comprise one or more mono-substituted IAA derivatives and/or one or more di-substituted IAA derivatives and/or one or more multi-substituted IAA derivatives or mixtures thereof and may further comprise one or more additional plant growth regulators, for example, one or more auxins, one or more cytokinins, one or more gibberellins, one or more abscisic acids and mixtures thereof, etc. In some embodiments, the composition may comprise one or more mono-substituted IAA derivatives and/or one or more di-substituted IAA derivatives and/or one or more multi-substituted IAA derivatives and may further comprise one or more compounds selected from a group consisting of (2,4-Dichlorophenoxy)acetic acid (2, 4-D), 6-benzylaminopurine (BAP), abscisic acid (ABA), zeatin riboside, kinetin, (2-Isopentyl)adenine (2iP) and dicamba. In some embodiments, the composition may comprise a mono-substituted IAA derivative and may further comprise at least one plant growth regulating compound selected from a group consisting of one or more auxins, one or more cytokinins, one or more gibberellins, one or more abscisic acids and mixtures thereof. In some embodiments, the composition may comprise 5-BrIAA and may further comprise at least one plant growth regulating compound selected from a group consisting of one or more auxins, one or more cytokinins, one or more gibberellins, one or more abscisic acids and mixtures thereof. In some embodiments, the composition may comprise 5-BrIAA and may further comprise at least one compound selected from a group consisting of 2, 4-D, BAP, ABA, zeatin riboside, kinetin, 2iP and dicamba. In some embodiments, the composition may comprise 5-BrIAA, 2,4-D, BAP and ABA. In some embodiments, the composition may comprise 5-BrIAA, zeatin riboside and ABA. In specific embodiments, the invention was exemplified with compositions comprising 5-BrIAA and a cytokinin to affect the growth of plants.

In one aspect, the present invention provides a composition formed by mixing one or more mono-substituted IAA derivatives and/or one or more di-substituted IAA derivatives and/or one or more multi-substituted IAA derivatives or mixtures thereof with one or more additional plant growth regulators, for example, one or more auxins, one or more cytokinins, one or more gibberellins, one or more abscisic acids and mixtures thereof, etc. In some embodiments, the composition may be formed by mixing one or more mono-substituted IAA derivatives and/or one or more di-substituted IAA derivatives and/or one or more multi-substituted IAA derivatives with one or more compounds selected from a group consisting of 2, 4-D, BAP, ABA, zeatin riboside, kinetin, 2iP and dicamba. In some embodiments, the composition can be formed by mixing a mono-substituted IAA with a plant growth regulating compound selected from a group consisting of one or more auxins, one or more cytokinins, one or more gibberellins, one or more abscisic acids and mixtures thereof. In some embodiments, the composition can be formed by mixing 5-BrIAA with a plant growth regulating compound selected from a group consisting of one or more auxins, one or more cytokinins, one or more gibberellins, one or more abscisic acids and mixtures thereof. In some embodiments, the composition can be formed by mixing 5-BrIAA with a plant growth regulating compound selected from a group consisting of 2, 4-D, BAP, ABA, zeatin riboside, kinetin, 2iP and dicamba. In some embodiments, the composition is formed by mixing 5-BrIAA, 2,4-D, BAP and ABA. In some embodiments, the composition may be formed by mixing 5-BrIAA, zeatin riboside and ABA.

It is a further object of the invention to provide a culture medium for affecting plant growth comprising a mixture of one or more indole-3-acetic acid (IAA) derivatives and one or more additional plant growth regulators (e.g. one or more auxins, cytokinins, giberellins and/or abscisic acids) as components of medium which sustains the plant during plant development or tissue regeneration and also serves as a vehicle whereby the one or more indole-3-acetic acid (IAA) derivatives may be applied. In one aspect, the medium may comprise one or more mono-substituted IAA derivatives and/or one or more di-substituted IAA derivatives and/or one or more multi-substituted IAA derivatives or mixtures thereof and may further comprise one or more additional plant growth regulators, for example, one or more auxins, one or more cytokinins, one or more gibberellins, one or more abscisic acids and mixtures thereof, etc. In some embodiments, the medium may comprise one or more mono-substituted IAA derivatives and/or one or more di-substituted IAA derivatives and/or one or more multi-substituted IAA derivatives and may further comprise one or more compounds selected from a group consisting of 2, 4-D, BAP, ABA, zeatin riboside, kinetin, 2iP and dicamba. In some embodiments, the medium may comprise a mono-substituted IAA derivative and may further comprise at least one plant growth regulating compound selected from a group consisting of one or more auxins, one or more cytokinins, one or more gibberellins, one or more abscisic acids and mixtures thereof. In some embodiments, the medium may comprise 5-BrIAA and may further comprise at least one plant growth regulating compound selected from a group consisting of one or more auxins, one or more cytokinins, one or more gibberellins, one or more abscisic acids and mixtures thereof. In some embodiments, the medium may comprise 5-BrIAA and may further comprise at least one compound selected from a group consisting of 2, 4-D, BAP, ABA, zeatin riboside, kinetin, 2iP and dicamba. In some embodiments, the medium may comprise 5-BrIAA, 2,4-D, BAP and ABA. In some embodiments, the medium may comprise 5-BrIAA, zeatin riboside and ABA. In specific embodiments, the invention was exemplified with compositions comprising 5-BrIAA and a cytokinin to affect the growth of plants.

It is an object of the present invention to provide a medium for the formation of a callus, preferably, an embryogenic callus, from a plant sample. In some embodiments, the callus formation medium may comprise a callus inducing amount of one or more plant growth regulating compounds selected from a group consisting of auxins, cytokinins, giberellins and abscisic acids. In some preferred embodiments, the callus formation medium comprises one or more mono-substituted IAA derivatives and/or one or more di-substituted IAA derivatives and/or one or more multi-substituted IAA derivatives or mixtures thereof and further comprises one or more additional plant growth regulators, for example, one or more auxins, one or more cytokinins, one or more gibberellins, one or more abscisic acids and mixtures thereof, etc. In some embodiments, the callus formation medium may comprise one or more mono-substituted IAA derivatives and/or one or more di-substituted IAA derivatives and/or one or more multi-substituted IAA derivatives and may further comprise one or more compounds selected from a group consisting of 2, 4-D, BAP, ABA, zeatin riboside, kinetin, 2iP and dicamba. In some embodiments, the callus formation medium comprises 5-BrIAA and a plant growth regulating compound selected from a group consisting of one or more auxins, one or more cytokinins, one or more gibberellins, one or more abscisic acids and mixtures thereof. In some embodiments, the callus formation medium comprises 5-BrIAA and a plant growth regulating compound selected from a group consisting of 2, 4-D, BAP, ABA, zeatin riboside, kinetin, 2iP and dicamba. In some embodiments, the callus formation medium comprises 5-BrIAA, 2,4-D, BAP and ABA. In some embodiments, the medium may comprise 5-BrIAA.

It is an object of the present invention to provide a medium for the regeneration a plant sample. In some embodiments, the plant sample may be a callus, preferably an embryogenic callus. In some embodiments, the medium may comprise a regeneration inducing amount of one or more plant hormones selected from a group consisting of auxins, cytokinins, giberellins and abscisic acids. In some preferred embodiments, the regeneration medium comprises one or more mono-substituted IAA derivatives and/or one or more di-substituted IAA derivatives and/or one or more multi-substituted IAA derivatives or mixtures thereof and further comprises one or more additional plant growth regulators, for example, one or more auxins, one or more cytokinins, one or more gibberellins, one or more abscisic acids and mixtures thereof, etc. In some embodiments of the present invention, the regeneration medium may comprise one or more mono-substituted IAA derivatives and/or one or more di-substituted IAA derivatives and/or one or more multi-substituted IAA derivatives and mixtures thereof and may further comprise one or more compounds selected from a group consisting of 2,4-D, BAP, ABA, zeatin riboside, kinetin, 2iP and dicamba. In some embodiments, the regeneration medium comprises 5-BrIAA and a plant growth regulating compound selected from a group consisting of one or more auxins, one or more cytokinins, one or more gibberellins, one or more abscisic acids and mixtures thereof. In some embodiments, the regeneration medium comprises 5-BrIAA, zeatin riboside and ABA.

It is an additional object of the invention to provide a method of affecting plant growth which comprises the step of applying to a plant sample an effective amount of a plant growth affecting composition comprising one or more mono-substituted IAA derivatives and/or one or more di-substituted IAA derivatives and/or one or more multi-substituted IAA derivatives or mixtures thereof and further comprising one or more additional plant growth regulators, for example, one or more auxins, one or more cytokinins, one or more gibberellins, one or more abscisic acids and mixtures thereof, etc. In some embodiments of the present invention, the composition may comprise one or more mono-substituted IAA derivatives and/or one or more di-substituted IAA derivatives and/or one or more multi-substituted IAA derivatives and mixtures thereof and may further comprise one or more compounds selected from a group consisting of 2, 4-D, BAP, ABA, zeatin riboside, kinetin, 2iP and dicamba. In some embodiments, the composition comprises 5-BrIAA and a plant growth regulating compound selected from a group consisting of one or more auxins, one or more cytokinins, one or more gibberellins, one or more abscisic acids and mixtures thereof. In specific embodiments, the invention was exemplified with compositions comprising 5-BrIAA and a cytokinin to affect the growth of plants. In some embodiments, the method may further comprise a step of incubating the plant sample in the presence of a plant growth affecting composition. In some embodiments, the plant sample may be an entire plant, a plant locus, a plant cell, a plant tissue, a plant seed or a portion of any of these. In some preferred embodiments, the plant sample is all or a portion of a transgenic plant.

It is an object of the present invention to provide a method of regenerating a plant from a plant sample, comprising the steps of providing a sample from a plant, culturing the sample in contact with a regeneration medium under conditions causing the regeneration of the plant sample, the regeneration medium comprising one or more mono-substituted IAA derivatives and/or one or more di-substituted IAA derivatives and/or one or more multi-substituted IAA derivatives or mixtures thereof and further comprising one or more additional plant growth regulators, for example, one or more auxins, one or more cytokinins, one or more gibberellins, one or more abscisic acids and mixtures thereof, etc. In some embodiments of the present invention, the regeneration medium may comprise one or more mono-substituted IAA derivatives and/or one or more di-substituted IAA derivatives and/or one or more multi-substituted IAA derivatives and may further comprise one or more compounds selected from a group consisting of 2, 4-D, BAP, ABA, zeatin riboside, kinetin, 2iP and dicamba. In some embodiments, the regeneration medium comprises 5-BrIAA and a plant growth regulating compound selected from a group consisting of one or more auxins, one or more cytokinins, one or more gibberellins, one or more abscisic acids and mixtures thereof. In some embodiments, the regeneration medium comprises 5-BrIAA, zeatin riboside and ABA. In some embodiments, the plant tissue sample may be derived from a mature plant tissue. Suitable plants include, but are not limited to, maize, wheat, sorghum, sugar beets, potatoes, soy beans, rice and other plants commonly cultivated as food sources. In some embodiments, the plant tissue is derived from a mature maize seed. In other embodiments, the method may further comprise the step of incubating the plant at a reduced temperature before excision of the sample. In some embodiments, the culturing step is performed in membrane-based liquid culture.

It is an object of the present invention to provide a method of regenerating a plant from a differentiated plant tissue, comprising the steps of providing a sample from a plant, the sample comprising differentiated plant tissue, culturing the sample in contact with a callus formation medium under conditions causing the formation of a callus, the callus formation medium comprising one or more mono-substituted IAA derivatives and/or one or more di-substituted IAA derivatives and/or one or more multi-substituted IAA derivatives or mixtures thereof and further comprising one or more additional plant growth regulators, for example, one or more auxins, one or more cytokinins, one or more gibberellins, one or more abscisic acids and mixtures thereof, etc. and regenerating a plant from the callus. In some embodiments, the callus formation medium may comprise one or more mono-substituted IAA derivatives and/or one or more di-substituted IAA derivatives and/or one or more multi-substituted IAA derivatives and may further comprise one or more compounds selected from a group consisting of 2, 4-D, BAP, ABA, zeatin riboside, kinetin, 2iP and dicamba. In some embodiments, the callus formation medium comprises 5-BrIAA and a plant growth regulating compound selected from a group consisting of one or more auxins, one or more cytokinins, one or more gibberellins, one or more abscisic acids and mixtures thereof. In some embodiments, the callus formation medium comprises 5-BrIAA and a plant growth regulating compound selected from a group consisting of 2, 4-D, BAP, ABA, zeatin riboside, kinetin, 2iP and dicamba. In some embodiments, the callus formation medium comprises 5-BrIAA, 2,4-D, BAP and ABA. In some embodiments, the method may further comprise the step of transferring the callus to a regeneration medium under conditions causing the regeneration of the callus, the regeneration medium comprising one or more mono-substituted IAA derivatives and/or one or more di-substituted IAA derivatives and/or one or more multi-substituted IAA derivatives or mixtures thereof and further comprising one or more additional plant growth regulators, for example, one or more auxins, one or more cytokinins, one or more gibberellins, one or more abscisic acids and mixtures thereof, etc. In some embodiments of the present invention, the regeneration medium may comprise one or more mono-substituted IAA derivatives and/or one or more di-substituted IAA derivatives and/or one or more multi-substituted IAA derivatives and mixtures thereof and may further comprise one or more compounds selected from a group consisting of 2,4-D, BAP, ABA, zeatin riboside, kinetin, 2iP and dicamba. In some embodiments, the regeneration medium comprises 5-BrIAA and a plant growth regulating compound selected from a group consisting of one or more auxins, one or more cytokinins, one or more gibberellins, one or more abscisic acids and mixtures thereof. In some embodiments, the regeneration medium comprises 5-BrIAA, zeatin riboside and ABA. In some embodiments, the callus formation medium is different from the regeneration medium. In some embodiments, the plant sample may be derived from a mature plant tissue. Suitable plants include, but are not limited to, maize, wheat, sorghum, sugar beets, potatoes, soy beans, rice and other plants commonly cultivated. In some embodiments, the plant sample may comprise all or a portion of a mature maize seed. In some embodiments, the method may comprise the additional step of amplifying the callus before transferring the callus to the regeneration medium. In other embodiments, the method may further comprise the step of incubating the plant tissue at a reduced temperature before excision of the sample. In some embodiments, a reduced temperature may be from about 0° C. to about 20° C., preferably from about 0° C. to about 10° C., more preferably from about 0° C. to about 5° C. and most preferably about 4° C. In some embodiments, the culturing step is performed in membrane-based liquid culture.

It is an object of the present invention to provide a method for the production of an embryogenic callus from a plant sample. In some embodiments, the method may comprise providing a plant sample, contacting the plant sample with a composition comprising one or more mono-substituted IAA derivatives and/or one or more di-substituted IAA derivatives and/or one or more multi-substituted IAA derivatives or mixtures thereof and further comprising one or more additional plant growth regulators, for example, one or more auxins, one or more cytokinins, one or more gibberellins, one or more abscisic acids and mixtures thereof, etc. and culturing the sample under conditions causing the formation of an embryogenic callus. In some embodiments, the composition may comprise one or more mono-substituted IAA derivatives and/or one or more di-substituted IAA derivatives and/or one or more multi-substituted IAA derivatives and may further comprise one or more compounds selected from a group consisting of 2, 4-D, BAP, ABA, zeatin riboside, kinetin, 2iP and dicamba. In some embodiments, the composition comprises 5-BrIAA and a plant growth regulating compound selected from a group consisting of one or more auxins, one or more cytokinins, one or more gibberellins, one or more abscisic acids and mixtures thereof. In some embodiments, the composition comprises 5-BrIAA and a plant growth regulating compound selected from a group consisting of 2, 4-D, BAP, ABA, zeatin riboside, kinetin, 2iP and dicamba. In some embodiments, the composition comprises 5-BrIAA, 2,4-D, BAP and ABA. In some preferred embodiments, the composition may comprise 5-BrIAA. In some embodiments, the sample may be derived from a mature plant. Suitable plants include, but are not limited to, maize, wheat, sorghum, sugar beets, potatoes, soy beans, rice and other plants commonly cultivated. In some embodiments, the plant sample may be derived from maize. In some embodiments, the sample may be a seed or a portion of a seed. In some embodiments, the plant sample may be derived from a maize seed. In some embodiments, the plant sample may be a seed or a portion of a seed from a maize variety selected from a group consisting of B73, H99 and PA91.

It is an object of the present invention to provide a method for the production of an embryogenic callus from a plant sample wherein the method comprises providing a plant sample, incubating the sample at a reduced temperature and culturing the plant sample in the presence of a callus formation medium, the callus formation medium comprising one or more mono-substituted IAA derivatives and/or one or more di-substituted IAA derivatives and/or one or more multi-substituted IAA derivatives or mixtures thereof and further comprising one or more additional plant growth regulators, for example, one or more auxins, one or more cytokinins, one or more gibberellins, one or more abscisic acids and mixtures thereof, etc. and regenerating a plant from the callus. In some embodiments, the callus formation medium may comprise one or more mono-substituted IAA derivatives and/or one or more di-substituted IAA derivatives and/or one or more multi-substituted IAA derivatives and may further comprise one or more compounds selected from a group consisting of 2, 4-D, BAP, ABA, zeatin riboside, kinetin, 2iP and dicamba. In some embodiments, the callus formation medium comprises 5-BrIAA and a plant growth regulating compound selected from a group consisting of one or more auxins, one or more cytokinins, one or more gibberellins, one or more abscisic acids and mixtures thereof. In some embodiments, the callus formation medium comprises 5-BrIAA and a plant growth regulating compound selected from a group consisting of 2, 4-D, BAP, ABA, zeatin riboside, kinetin, 2iP and dicamba. In some embodiments, the callus formation medium comprises 5-BrIAA, 2,4-D, BAP and ABA. In some preferred embodiments, the medium may comprise 5-BrIAA. In some embodiments, a portion of the sample may be excised and cultured after the sample has been incubated at a reduced temperature. In some embodiments, a reduced temperature may be from about 0° C. to about 20° C., preferably from about 0° C. to about 10° C., more preferably from about 0° C. to about 5° C. and most preferably about 4° C. In some embodiments, the plant sample may be derived from a mature plant. Suitable plants include, but are not limited to, maize, wheat, sorghum, sugar beets, potatoes, soy beans, rice and other plants commonly cultivated. In some embodiments, the plant sample may be derived from maize. In some embodiments, the plant sample may be a seed or a portion of a seed. In some embodiments, the plant sample may be derived from a maize seed. In some embodiments, the plant sample may be derived from a from a maize variety selected from a group consisting of B73, H99 and PA91. In some embodiments, the incubation step may be performed at 4° C. for from about 1 day to about 10 days. In some embodiments, the incubation step may be performed for 4 days.

It is an object of the present invention to provide a method of regenerating a shoot from a callus, comprising the steps of contacting a callus with a regeneration medium and incubating the callus under conditions causing the regeneration of a shoot from the callus. In some embodiments, the medium may comprise a regeneration inducing amount of one or more plant hormones selected from a group consisting of auxins, cytokinins, giberellins and abscisic acids. In some preferred embodiments, the regeneration medium comprises one or more mono-substituted IAA derivatives and/or one or more di-substituted IAA derivatives and/or one or more multi-substituted IAA derivatives or mixtures thereof and further comprises one or more additional plant growth regulators, for example, one or more auxins, one or more cytokinins, one or more gibberellins, one or more abscisic acids and mixtures thereof, etc. In some embodiments of the present invention, the regeneration medium may comprise one or more mono-substituted IAA derivatives and/or one or more di-substituted IAA derivatives and/or one or more multi-substituted IAA derivatives and mixtures thereof and may further comprise one or more compounds selected from a group consisting of 2,4-D, BAP, ABA, zeatin riboside, kinetin, 2iP and dicamba. In some embodiments, the regeneration medium comprises 5-BrIAA and a plant growth regulating compound selected from a group consisting of one or more auxins, one or more cytokinins, one or more gibberellins, one or more abscisic acids and mixtures thereof. In some embodiments, the regeneration medium comprises 5-BrIAA, zeatin riboside and ABA. In some embodiments, the callus may be derived from a mature plant. Suitable plants include, but are not limited to, maize, wheat, sorghum, sugar beets, potatoes, soy beans, rice and other plants commonly cultivated. In some embodiments, the callus may be derived from maize. In some embodiments, the callus may be derived from a seed or a portion of a seed. In some embodiments, the callus may be derived from a maize seed. In some embodiments, the callus may be derived from a from a maize variety selected from a group consisting of B73, H99 and PA91.

It is an object of the present invention to provide a method for the regeneration of a transformed plant, comprising the steps of providing a plant sample, culturing the plant sample in the presence of a callus formation medium, the callus formation medium comprising one or more mono-substituted IAA derivatives and/or one or more di-substituted IAA derivatives and/or one or more multi-substituted IAA derivatives or mixtures thereof and further comprising one or more additional plant growth regulators, for example, one or more auxins, one or more cytokinins, one or more gibberellins, one or more abscisic acids and mixtures thereof, etc., to produce an embryogenic callus, transforming the callus and incubating the transformed callus under conditions causing the regeneration of the callus. In some embodiments, the callus formation medium may comprise one or more mono-substituted IAA derivatives and/or one or more di-substituted IAA derivatives and/or one or more multi-substituted IAA derivatives and may further comprise one or more compounds selected from a group consisting of 2, 4-D, BAP, ABA, zeatin riboside, kinetin, 2iP and dicamba. In some embodiments, the callus formation medium comprises 5-BrIAA and a plant growth regulating compound selected from a group consisting of one or more auxins, one or more cytokinins, one or more gibberellins, one or more abscisic acids and mixtures thereof. In some embodiments, the callus formation medium comprises 5-BrIAA and a plant growth regulating compound selected from a group consisting of 2, 4-D, BAP, ABA, zeatin riboside, kinetin, 2iP and dicamba. In some embodiments, the callus formation medium comprises 5-BrIAA, 2,4-D, BAP and ABA. In some embodiments, the method may further comprise the step of transferring the callus to a regeneration medium under conditions causing the regeneration of the callus, the regeneration medium comprising one or more mono-substituted IAA derivatives and/or one or more di-substituted IAA derivatives and/or one or more multi-substituted IAA derivatives or mixtures thereof and further comprising one or more additional plant growth regulators, for example, one or more auxins, one or more cytokinins, one or more gibberellins, one or more abscisic acids and mixtures thereof, etc. In some embodiments of the present invention, the regeneration medium may comprise one or more mono-substituted IAA derivatives and/or one or more di-substituted IAA derivatives and/or one or more multi-substituted IAA derivatives and mixtures thereof and may further comprise one or more compounds selected from a group consisting of 2,4-D, BAP, ABA, zeatin riboside, kinetin, 2iP and dicamba. In some embodiments, the regeneration medium comprises 5-BrIAA and a plant growth regulating compound selected from a group consisting of one or more auxins, one or more cytokinins, one or more gibberellins, one or more abscisic acids and mixtures thereof. In some embodiments, the regeneration medium comprises 5-BrIAA, zeatin riboside and ABA. In some embodiments, the callus formation medium is different from the regeneration medium. In some embodiments, the plant tissue sample may be derived from a mature plant tissue. Suitable plants include, but are not limited to, maize, wheat, sorghum, sugar beets, potatoes, soy beans, rice and other plants commonly cultivated. In some embodiments, the plant sample may be derived from maize. In some embodiments, the plant sample may be a seed or a portion of a seed. In some embodiments, the plant sample may be derived from a maize seed. In some embodiments, the plant sample may a seed or a portion of a seed from a maize variety selected from a group consisting of B73, H99 and PA91. In some embodiments, the method may comprise the additional step of amplifying the callus before transferring the callus to the regeneration medium. In other embodiments, the method may further comprise the step of incubating the plant tissue at a reduced temperature before excision of the sample. In some embodiments, a reduced temperature may be from about 0° C. to about 20° C., preferably from about 0C to about 10° C., more preferably from about 0° C. to about 5° C. and most preferably about 4° C. In some embodiments, one or more of the steps are performed in membrane-based liquid culture.

It is an object of the present invention to provide a method for the regeneration of a transformed plant, comprising the steps of providing a plant sample, transforming the plant sample and culturing the plant sample in the presence of a callus formation medium to produce a transformed callus, the callus formation medium comprising one or more mono-substituted IAA derivatives and/or one or more di-substituted IAA derivatives and/or one or more multi-substituted IAA derivatives or mixtures thereof and further comprising one or more additional plant growth regulators, for example, one or more auxins, one or more cytokinins, one or more gibberellins, one or more abscisic acids and mixtures thereof, etc. and incubating the transformed callus under conditions causing the regeneration of the callus. In some embodiments, the callus formation medium may comprise one or more mono-substituted IAA derivatives and/or one or more di-substituted IAA derivatives and/or one or more multi-substituted IAA derivatives and may further comprise one or more compounds selected from a group consisting of 2, 4-D, BAP, ABA, zeatin riboside, kinetin, 2iP and dicamba. In some embodiments, the callus formation medium comprises 5-BrIAA and a plant growth regulating compound selected from a group consisting of one or more auxins, one or more cytokinins, one or more gibberellins, one or more abscisic acids and mixtures thereof. In some embodiments, the callus formation medium comprises 5-BrIAA and a plant growth regulating compound selected from a group consisting of 2, 4-D, BAP, ABA, zeatin riboside, kinetin, 2iP and dicamba. In some embodiments, the callus formation medium comprises 5-BrIAA, 2,4-D, BAP and ABA. In some embodiments, the method may further comprise the step of transferring the callus to a regeneration medium under conditions causing the regeneration the callus, the regeneration medium comprising one or more mono-substituted IAA derivatives and/or one or more di-substituted IAA derivatives and/or one or more multi-substituted IAA derivatives or mixtures thereof and further comprising one or more additional plant growth regulators, for example, one or more auxins, one or more cytokinins, one or more gibberellins, one or more abscisic acids and mixtures thereof, etc. In some embodiments of the present invention, the regeneration medium may comprise one or more mono-substituted IAA derivatives and/or one or more di-substituted IAA derivatives and/or one or more multi-substituted IAA derivatives and mixtures thereof and may further comprise one or more compounds selected from a group consisting of 2,4-D, BAP, ABA, zeatin riboside, kinetin, 2iP and dicamba. In some embodiments, the regeneration medium comprises 5-BrIAA and a plant growth regulating compound selected from a group consisting of one or more auxins, one or more cytokinins, one or more gibberellins, one or more abscisic acids and mixtures thereof. In some embodiments, the regeneration medium comprises 5-BrIAA, zeatin riboside and ABA. In some embodiments, the callus formation medium is different from the regeneration medium. In some embodiments, the plant tissue sample may be derived from a mature plant tissue. Suitable plants include, but are not limited to, maize, wheat, sorghum, sugar beets, potatoes, soy beans, rice and other plants commonly cultivated. In some embodiments, the plant sample may be derived from maize. In some embodiments, the plant sample may be a seed or a portion of a seed. In some embodiments, the plant sample may be derived from a maize seed. In some embodiments, the plant sample may a seed or a portion of a seed from a maize variety selected from a group consisting of B73, H99 and PA91. In some embodiments, the method may comprise the additional step of amplifying the callus before transferring the callus to the regeneration medium. In other embodiments, the method may further comprise the step of incubating the plant tissue at a reduced temperature before excision of the sample. In some embodiments, a reduced temperature may be from about 0° C. to about 20° C., preferably from about 0° C. to about 10° C., more preferably from about 0° C. to about 5° C. and most preferably about 4° C. In some embodiments, one or more of the steps are performed in membrane-based liquid culture.

It is an object of the present invention to provide a method for the regeneration of a transformed plant, comprising the steps of providing a plant sample, transforming the plant sample and culturing the plant sample in the presence of a regeneration medium comprising one or more mono-substituted IAA derivatives and/or one or more di-substituted IAA derivatives and/or one or more multi-substituted IAA derivatives or mixtures thereof and further comprising one or more additional plant growth regulators, for example, one or more auxins, one or more cytokinins, one or more gibberellins, one or more abscisic acids and mixtures thereof, etc. In some embodiments of the present invention, the regeneration medium may comprise one or more mono-substituted IAA derivatives and/or one or more di-substituted IAA derivatives and/or one or more multi-substituted IAA derivatives and mixtures thereof and may further comprise one or more compounds selected from a group consisting of 2,4-D, BAP, ABA, zeatin riboside, kinetin, 2iP and dicamba. In some embodiments, the regeneration medium comprises 5-BrIAA and a plant growth regulating compound selected from a group consisting of one or more auxins, one or more cytokinins, one or more gibberellins, one or more abscisic acids and mixtures thereof. In some embodiments, the regeneration medium comprises 5-BrIAA, zeatin riboside and ABA. In some embodiments, the plant tissue sample may be derived from a mature plant tissue. Suitable plants include, but are not limited to, maize, wheat, sorghum, sugar beets, potatoes, soy beans, rice and other plants commonly cultivated. In some embodiments, the plant sample may be derived from maize. In some embodiments, the plant sample may be a seed or a portion of a seed. In some embodiments, the plant sample may be derived from a maize seed. In some embodiments, the plant sample may a seed or a portion of a seed from a maize variety selected from a group consisting of B73, H99 and PA91. In other embodiments, the method may further comprise the step of incubating the plant tissue at a reduced temperature before excision of the sample. In some embodiments, a reduced temperature may be from about 0° C. to about 20° C., preferably from about 0° C. to about 10° C., more preferably from about 0° C. to about 5° C. and most preferably about 4° C. In some embodiments, one or more of the steps are performed in membrane-based liquid culture.

The present invention also relates to kits for carrying out the methods of the invention, and particularly for use in generating a callus, preferably an embryogenic callus. In some preferred embodiments, the present invention may provide kits for the transformation and/or regeneration of plant samples. Such kits may include one or more containers, one or more medium formulations, solid supports such as membranes and/or agar. Such kits may optionally comprise one or more additional components selected from the group consisting of one or more suitable buffers, one or more cytokinins and one or more auxins.

Other preferred embodiments of the present invention will be apparent to one of ordinary skill in light of what is known in the art, in light of the following drawings and description of the invention, and in light of the claims.

### BRIEF DESCRIPTION OF THE DRAWINGS

FIG. 1 is a schematic representation of a maize seed showing the excision of a suitable tissue sample for culture according to the methods of the present invention.

### DETAILED DESCRIPTION OF THE INVENTION

In the description that follows, a number of terms that are commonly used by those skilled in the art of biotechnology are utilized extensively. In order to provide a clear and more consistent understanding of the specification and claims, including the scope to be given such terms, the following definitions are provided.

The terms IAA derivative or 5-bromoindole-3-acetic acid or 5-BrIAA as used herein refer not only to the free acid form but also to an amide, an ester or a salt form of the IAA derivative or 5-BrIAA. Suitable IAA derivatives are described in U.S. patent application Ser. No. 08/758,416 entitled Auxinic Analogues of Indole-3-Acetic Acid, filed Nov. 29, 1996, which is specifically incorporated herein by reference. Included in the meaning of IAA derivative or 5-BrIAA are, for example, such salt and ester derivatives as the sodium, potassium, ammonium, dimethylamine, ethanolamine, etc. salts and amides and the lower alkyl esters.

The term plant growth regulator or hormone as used herein refers to a naturally occurring or synthetic compound that acts as a hormone in affecting plant growth. Important growth regulators are exemplified by auxins, cytokinins, abscisic acids and gibberellins.

The term auxin as used herein refers to a plant growth regulator that affects the growth of plants. An auxin is exemplified by a compound such as indole-3-acetic acid (IAA), indole-3-butyric acid (IBA), 2,4-dichlorophenoxyacetic acid (2,4-D), naphthaleneacetic acid (NAA), 5,6-dichloroindole-3-acetic acid (5,6-Cl₂-IAA) and the like.

The term cytokinin as used herein refers to a plant growth regulator that affects the growth of plants. A cytokinin is exemplified by a compound such as 6-benzylamino purine (BAP), N⁶ (Δ₂-isopentenyl) adenine (2iP), isopentenylpyrophosphate (ipp), 6-(4-hydroxy-3-methyl-2-transbetenylamino)purine (zeatin), 6-furfurylaminopurine (kinetin) and the like. A compound can be tested for auxin activity using a bioassay, e.g., the elongation of coleoptiles of Avena sativa (Bottger, et al., (1978) Planta 140:89) or the root growth inhibition of Chinese cabbage (Marumo, et al., (1974) in Plant Growth Substance, p. 419, Hirokawa Publishing Co., Inc., Tokyo) or the hypocotyl swelling of mung bean (Marumo, et al., (1974) supra). Cytokinin activity may be measured in assays designed to evaluate the promotion of growth in plants (e.g., tobacco bioassays, etc.) as is well known in the art (Skoog, et al., (1967) Phytochem 6:1169-1192; Morris, (1986) Ann. Rev. Plant Physiol. 37:509-538; Horgan, (1984) in Advanced Plant Physiol. (Wilkins, M. B., ed.) pp. 53-75, Pitman Publishing, London; Letham and Palni, (1983) Ann. Rev. Plant Physiol. 34:163-197; and Chen, (1981) in Metabolism and Molecular Activities of Cytokinins (Guern, J. and Peaud-Lenoel, C., eds., Springer, New York, pp. 34-43). Variations of the cytokinin/auxin concentration ratio cause the enhancement in plant growth to occur preferentially in certain tissues. For example, a high cytokinin/auxin ratio promotes growth of shoots, whereas a low cytokinin to auxin ratio promotes the growth of roots (Depicker, et al., (1983) in Genetic Engineering of Plants, T. Kosunge, C. P. Meredith and A. Hollaender, eds., Plenum Press, New York, p. 154).

The term medium or culture medium as used herein refers to a composition capable of maintaining viability, supporting growth and/ or regeneration of a plant sample. Commonly used media include MS medium, commercially available from Life Technologies, Inc. Rockville, Md. and N6 medium, commercially available from Sigma, St. Louis, Mo.

The term plant sample as used herein refers to a whole plant or a part of a plant. This term is seen to include, but is not limited to, a locus of a plant, a cell of a plant, a tissue of a plant, an explant, seeds of a plant, or portions of a seeds of a plant. This term further contemplates a plant in the form of a suspension culture or a tissue culture including, but not limited to, a culture of calli, protoplasts, embryos, organs, organelles, etc.

The term transformed as it relates to plants, plant samples and/or plant tissues as used herein refers to introduction of a foreign nucleic acid into a plant, plant sample and/or plant tissue. The foreign nucleic acid may be DNA, RNA, a mixture of DNA and RNA or a hybrid in which one or more molecules contain both ribo- and deoxyribo-nucleotides.

The term transgenic plant or transgenic plant tissue as used herein refers to a plant or plant tissue stably transformed with a foreign nucleic acid molecule introduced into the individual plant cells.

The term expression refers to the synthesis of an RNA from a DNA molecule. Transient expression is expression that occurs for only a finite period of time. In general, transient expression will be used to refer to the expression that occurs from a DNA molecule that has been introduced into a host cell immediately after introduction of the DNA.

The term genetic engineering as used herein refers to the introduction of foreign, often chimeric, genes into one or more plant cells which can be regenerated into whole, viable plants. In some cases the plants thus produced can be self-pollinated or cross-pollinated with other plants of the same species so that the foreign gene, carried in the germ line, can be inserted into or bred into agriculturally useful plant varieties.

The term regeneration as used herein refers to the production of at least one newly developed or regenerated plant tissue, e.g., root, shoot, callus, etc., from a cultured plant sample or unit, e.g., leaf disc, seed, etc.

The terms percent regeneration, % regeneration or regeneration efficiency as used herein refer to the number of tissue cultured plant units producing at least one newly developed or regenerated tissue as a percentage of the total number of tissue cultured plant units, e.g., (# of plant units having newly developed tissue/total # of plant units)×100.

The terms affecting plant growth or growth affecting or affector or affect as used herein refer to any one of a number of plant responses which improve or change, relative to what is observed in the absence of the growth regulator, some characteristic of overall plant growth including, but not limited to, stimulation of seed germination, inducing rooting, suppressing shooting, promoting cell proliferation, stimulating callus growth, etc.

The term effective amount as used herein refers to the amount or concentration of a compound that is a plant growth regulator or hormone administered to a plant such that the compound stimulates or invokes one or more of a variety of plant growth responses. A plant growth response includes, but is not limited to, the induction of stem elongation, the promotion of root formation, the stimulation of callus formation, enhancement of leaf growth, stimulation of seed germination, increase in the dry weight content of a number of plants and plant parts, and the like.

The phrase membrane-based liquid culture as used herein refers to a method of culturing plant samples in which a sample is placed on top of a membrane which is supported by a float on the top of a liquid media. A more detailed discussion of the technique is provided in Lin, et al., In vitro, 31:30A (1995) and Lin, et al., Focus 17(3):95 (1995). The technique can be performed with reagents and equipment that are commercially available from Life Technologies, Inc. Rockville Md.

The present invention relates to the discovery that IAA derivatives, and especially 5-BrIAA, have utility as plant growth affecting compounds. 5-BrIAA was found to be superior to IAA in functioning as an auxin in both monocots and dicots. Accordingly, the present invention contemplates novel compositions for affecting plant growth comprising at least one IAA derivative. In some embodiments, the novel compositions of the present invention will comprise 5-BrIAA.

In some preferred embodiments, the growth effect of the novel compositions of the present invention is the stimulation of the production of an embryogenic callus from a plant tissue. For example, 5-BrIAA was between two and four times more effective than IAA in stimulating the regeneration of green calli from Arabidopsis thaliana. The effect of 5-BrIAA is all the more remarkable in light of the prior art teaching for Arabidopsis tissue culture responses that “callus induction and regeneration frequencies are high for root, lower for anther and stem and lowest for leaf explants.” In accordance with the present invention, 5-BrIAA gave an efficiency of 100% for regeneration from Arabidopsis thaliana leaves (see U.S. Pat. No. 5, 674,731).

In some preferred embodiments, the growth effect of the novel compositions of the present invention may be the stimulation of regeneration of a plant sample. The compositions of the present invention are unexpectedly superior to prior art compositions for the regeneration of a plant sample. Superiority of 5-BrIAA was also observed in monocot regeneration. Prior art methods used to obtain tissue regeneration from monocotyledonous plants, for example, rice, require approximately three months and incubation of immature seeds in two or more different culture media. In contrast, in accordance with the present invention using 5-BrIAA as auxin, regeneration of shoots from rice embryonic callus derived from mature seeds was obtained in about one and a half months, requiring only one incubation medium comprising 5-BrIAA and a cytokinin (e.g., BAP) and yielding a regeneration efficiency of 100%. In all bioassays performed to show regeneration from plant tissue and from transgenic plant tissue, 5-BrIAA functioned as an auxin to stimulate growth at least as well as, and in many cases better than, IAA, the auxin standard of the art.

Growth affecting compositions of the present invention may comprise one or more indole-3-acetic acid (IAA) derivatives optionally in a mixture with one or more additional plant growth regulators, for example, an auxin, a cytokinin, a gibberellin, an abscisic acid etc. In some preferred embodiments, 5-BrIAA, or a mixture of 5-BrIAA and one or more additional plant growth regulators, such as an auxin, an abscisic acid, a cytokinin, a gibberellin or the like, may be mixed with a carrier or auxiliary nutrients. The use of BAP, 2iP and kinetin has been exemplified in particular embodiments of this invention. It is contemplated that other cytokinins or other plant growth regulators known to the art can be utilized with 5-BrIAA to make a growth affecting composition of the invention. It is also contemplated that more than one cytokinin or a different plant growth regulator (e.g., gibberellin, etc.) can be mixed with 5-BrIAA to make a growth enhancing composition of the invention. Also, the choice of plant growth regulator can be varied at different stages of the incubation or application cycles characterizing the growth of a particular plant. Plant growth regulators are known to the art and include, but are not limited to, BAP, 2iP, ipp, zeatin, kinetin, gibberellin, and the like, as described in Skoog, et al. (1967) Phytochemistry 6:1169-1192 and Theologis, (1989) in Plant Biotechnology (Kung and Arntzen, eds.) Butterworth Publishers, Stoneham, Mass.

The practice of the present invention contemplates a wide variety of plant growth responses including, but not limited to, stimulation of seed germination and breaking of dormancy; increasing yields; hastening ripening and color production in fruit; increasing flowering and fruiting; stimulating shoot formation; inducing callus development; inducing rooting and causing cell proliferation; increasing the hardiness of various plant species; and increasing the dry weight content of a number of plants and plant parts. In addition to these categories of responses, any other modification of a plant, seed, fruit or vegetable, so long as the net result is to affect the growth or maximize any beneficial or desired property of the agricultural and horticultural crop or seed, is intended to be included within the scope of advantageous responses achieved by the practice of the present invention.

Suitable applications of the growth enhancing compositions of the present invention to cultures of plant tissues were shown to induce the regeneration of shoots, roots or calli. This effect was exemplified in both monocotyledonous and dicotyledonous plant species and is applicable to a wide variety of plants.

The compositions of the instant invention were further utilized for plant regeneration from transgenic plants.

Genetic engineering of plants generally involves two complementary processes. The first process involves the genetic transformation of one or more plant cells of a specifically characterized type. By transformation it is meant that a foreign gene, typically a chimeric gene construct, is introduced into the genome of the individual plant cells, typically through the aid of a vector which has the ability to transfer the gene of interest into the genome of the plant cells in culture. The second process then involves the regeneration of the transformed plant cells into whole sexually competent plants. Neither the transformation nor regeneration process need be 100% successful but must have a reasonable degree of reliability and reproducibility so that a reasonable percentage of the cells can be transformed and regenerated into whole plants.

The two processes, transformation and regeneration, must be complementary. The complementarity of the two processes must be such that the tissues which are successfully genetically transformed by the transformation process must be of a type and character, and must be in sufficient health, competency and vitality, so that they can be successfully regenerated into whole plants.

Successful transformation and regeneration techniques have been demonstrated for monocots and dicots in the prior art. For example, the transformation and regeneration of tobacco plants was reported in Barton, et al., Cell 32:1033 (April 1983), whereas the regeneration of cotton is described in Umbeck, U.S. Pat. No. 5,004,863, issued Apr. 2, 1991. Further, transformation and regeneration of rice was described by Abdullah, et al. (1986) Bio/Technology 4:1087-1090, whereas maize was transformed and regenerated as described in Rhodes, et al. (1988) Bio/Technology 6:56-60 and Science 240:204-207. In addition, the regeneration of maize from cultures derived from mature seeds is shown in U.S. Pat. No. 4,806,483 issued on Feb. 21, 1989 and from cultures derived from immature embryos in U.S. Pat. No. 5,134,074 issued Jul. 28, 1992.

The most common methodology used for the transformation of cells of dicot plant species involves the use of the plant pathogen Agrobacterium tumefaciens. Although Agrobacterium-mediated transformation has been achieved in some monocots, other methods of gene transfer have been more effective, e.g., the polyethylene glycol method, electroporation, direct injection, particle bombardment, etc., as described by Wu in Plant Biotechnology (1989) pp. 35-51, Butterworth Publishers, Stoneham, Mass. The present invention will be useful with any method of transformation that includes plant regeneration steps.

In a specific embodiment, the invention envisions the genetic transformation of plant tissues in culture. In some embodiments, the tissues may be derived from leaf discs or hypocotyl explants. The transformed tissues can be induced to form plant tissue structures, which can be regenerated into whole plants. In other embodiments, the invention contemplates the transformation of tissues in culture derived from a mature seed. The transformed tissue may be regenerated into whole plants. In some embodiments, the tissue may be derived from mature maize seed.

In some embodiments, the transformation technique of the present invention may be one which makes use of the Ti plasmid of A. tumefaciens. In using an A. tumefaciens culture as a transformation vehicle, it is most advantageous to use a non-oncogenic strain of the Agrobacterium as the vector carrier so that normal non-oncogenic differentiation of the transformed tissue is possible. To be effective once introduced into plant cells, the chimeric construct including a foreign gene of interest may contain a promoter which is effective in plant cells to cause transcription of the gene of interest and a polyadenylation sequence or transcription control sequence also recognized in plant cells. Promoters known to be effective in plant cells include the nopaline synthase promoter, isolated from the T-DNA of Agrobacterium, and the cauliflower mosaic virus 35S promoter. Other suitable promoters are known in the art. It is also preferred that the vector which harbors the foreign gene of interest also contain therein one or more selectable marker genes so that the transformed cells can be selected from non-transformed cells in culture. In many applications, preferred marker genes include antibiotic resistance genes and/or herbicide resistance genes so that the appropriate antibiotic and/or herbicide can be used to segregate and select for transformed cells from among cells which are not transformed.

The details of the construction of the vectors containing such foreign genes of interest are known to those skilled in the art of plant genetic engineering and do not differ in kind from those practices which have previously been demonstrated to be effective in tobacco, petunia and other model plant species. The foreign gene should obviously be selected as a marker gene (Jefferson, et al. (1987) EMBO J. 6:3901-3907) or to accomplish some desirable effect in plant cells. This effect may be growth promotion, disease resistance, a change in plant morphology or plant product quality, or any other change which can be accomplished by genetic manipulation. The chimeric gene construction can code for the expression of one or more exogenous proteins, or can cause the transcription of negative strand RNAs to control or inhibit either a disease process or an undesirable endogenous plant function.

To initiate the transformation and regeneration process for plant tissues, it is necessary to first surface sterilize tissues to prevent inadvertent contamination of the resulting culture. If the tissues are seeds, the seeds may be allowed to germinate on an appropriate germinating medium containing a fungicide. Four to ten days after germination the hypocotyl portion of the immature plant is removed and sectioned into small segments averaging approximately 0.5 centimeters apiece. The hypocotyl explants are allowed to stabilize and remain viable in a liquid or agar plant tissue culture medium.

Once the tissues have stabilized, they can promptly be inoculated with a suspension culture of transformation competent non-oncogenic Agrobacterium. The inoculation process is allowed to proceed for a short period, e.g., two days, at room temperature, i.e., 24° C.

At the end of the inoculation time period, the remaining treated tissues can be transferred to a selective agar medium, which contains one or more antibiotics toxic to Agrobacterium but not to plant tissues, at a concentration sufficient to kill any Agrobacterium remaining in the culture. Suitable antibiotics for use in such a medium include, but are not limited to, carbenicillin, cefotaxime, etc. as the bacteriocide for Agrobacterium and kanamycin, hygromycin, PPT etc. as the selective antibiotic for transformed plant tissues.

The tissues are now cultivated on a tissue culture medium which, in addition to its normal components, contains a selection agent. The selection agent, exemplified herein by kanamycin, is toxic to non-transformed cells but not to transformed cells which have incorporated genetic resistance to the selection agent and are expressing that resistance. A suitable tissue culture medium is the MS medium to which is added the phytohormones 5-BrIAA and a cytokinin, with or without antibiotics. The surviving transformed tissues may be transferred to a secondary medium to induce tissue regeneration. The surviving transformed tissue will thus continue to be regenerated into a whole plant through the regeneration technique of the present invention or through any other alternative plant regeneration protocols.

The methods of the present invention include methods for the production of a callus, preferably an embryogenic callus, from a plant sample. It has been unexpectedly found that the efficiency of the production of calli from plant samples can be increased by subjecting the samples to an incubation at a reduced temperature. By reduced temperature it is meant that the temperature of the incubation will be lower than room temperature. In some embodiments, the samples may be incubated at a temperature of from about 0° C. to about 150° C., preferably from about 0° C. to about 10° C. and more preferably from about 0° C. to about 5° C. In other embodiments, the plant sample may be frozen. The incubation at a reduced temperature may be performed for a period of time sufficient to stimulate the production of calli from plant samples. In some embodiments, the incubation may be performed for from about 1 hour to about 10 days, preferably from about 1 day to about 7 days and more preferably for about 4 days. In some embodiments, the incubation may be performed while the sample is exposed to the ambient atmosphere. For example, the sample may be incubated in a refrigerator. In some embodiments, the incubation may be performed while the sample is exposed to a liquid. In some embodiments, the sample may be incubated at a reduced temperature while soaking in water. In other embodiments, the sample may be incubated at a reduced temperature while soaking in a solution of salts and/or buffers. In some embodiments, the samples may soaked in a solution comprising plant growth affecting compounds. In some embodiments, the sample may be incubated at a reduced temperature in a solution comprising one or more of the IAA derivatives of the present invention, for example, 5-BrIAA.

The precise amount of growth affecting compositions employed in the practice of the present invention will depend upon the type of response desired, the formulation used and the type of plant treated. The invention contemplates the use of a ratio of cytokinin concentration to auxin concentration of between approximately 50.0 and 0.001, and preferably between approximately 5.0 and 0.05, and more preferably between approximately 2.0 and 0.25. The concentrations of the growth affecting compounds will typically be within the range of from about 1 μg/mL to about 100 mg/mL, preferably from about 500 μg/mL to about 10 mg/mL and more preferably from about 1 mg/mL to about 5 mg/mL.

The chemical compounds employed as active components of the growth enhancing compositions of the present invention may be prepared in accordance with processes well known in the prior art or may be obtained commercially from readily available sources.

The present compositions may be applied at any developmental stage of the plant species to obtain plant hormone or maintenance effects throughout maturity and to expedite regrowth in damaged tissues during early developmental stages, depending upon the concentration used, the formulation employed and the type of plant species treated.

The compositions of the present invention are preferably used in conjunction with specific auxiliary nutrients or other plant growth regulators in precise proportions to achieve a particular synergistic, growth enhancing response in various type of plants. The present compositions may additionally be used in association with fungicides to increase the disease resistance of various plants, making the plant tissue resistant to invasion by pathogens by influencing the enzyme and plant processes which regulate natural disease immunity. While the present compositions possess essentially no phytotoxic activity of their own, they may sometimes be used in conjunction with herbicides to stimulate the growth of unwanted plants in order to make such plants more susceptible to a herbicide. However, it is preferred to regard the results achieved in the practice of the present invention as growth enhancing responses in agricultural and horticultural crops, as well as perennial and annual household plants species.

The following examples are illustrative of the wide range of plant growth responses that can be realized by application of a preferred composition of the present invention to various plant species. Nevertheless, there is no intention that the invention be limited to these optimum ratios of active components since workers in the art will find the compositions of the invention set forth hereinabove to be effective growth enhancers. Also, it should readily occur to one skilled in the art that the recognition of improved results using the compositions according to the present invention in connection with other plants, seeds, fruits and vegetables not specifically illustrated herein is readily within the capabilities of one skilled in the art. The following examples serve to illustrate the utility of the invention without limiting its scope.

It will be readily apparent to one of ordinary skill in the relevant arts that other suitable modifications and adaptations to the methods and applications described herein are obvious and may be made without departing from the scope of the invention or any embodiment thereof. Having now described the present invention in detail, the same will be more clearly understood by reference to the following examples, which are included herewith for purposes of illustration only and are not intended to be limiting of the invention.

### EXAMPLE 1

### Preparation of Culture Media

For MS salt based medium, GIBCO BRL Murashige and Skoog (MS) Complete Medium-50X Concentrate (Cat. # 10494-011) was used. 20 ml of each of the components Salt I, Salt II and Acid Soluble was mixed with 940 ml of sterilized water for membrane based liquid growth format. When the culturing was done in a semi-solid format, either 0.8% agar or 0.25% Gelrite (Sigma. Cat. # G1910) was included in the mixture. For N6 salt +B5 vitamin, CHU (N6) basal salt mixture (Sigma, Cat. # C1416) was mixed with 1 ml of Gamborg's vitamin solution (Sigma, Cat# G1019) in a final volume of 1 liter of medium preparation.

The base media were supplemented with one of the plant growth regulator mixtures. The regulators added to the media and their final concentration in the media are shown in Table 1.

TABLE 1

| | Plant growth | |
|---|---|---|
| Stages of tissue | formulation | Formulation of plant |
| culture | mixture | growth regulator mixtures |
| Stimulation of | SECF-1 | 5-BrIAA 4 mg/l + 2,4-D 1 mg/l + |
| Embryogenic | | BAP 1 mg/l + ABA 2 mg/l |
| Callus Formulation | | |
| (SECF) | | |
| | SECF-2 | 5-BrIAA 4 mg/l + Zeatin riboside |
| | | 1 mg/l + BAP 1 mg/l + ABA |
| | | 2 mg/l |
| | SECF-3 | 5-BrIAA 4 mg/l + 2,4-D 1 mg/l + |
| | | Dicamba 1 mg/l + BAP 1 mg/l + |
| | | ABA 2 mg/l |
| | SECF-4 | BAP 1 mg/l + 2iP 1 mg/l + Zeatin |
| | | riboside 1 mg/l + Kinetin 1 mg/L + |
| | | Dicamba 1 mg/l |
| Amplification of | AEC | 2,4-D 2 mg/l |
| Embryogenic | | |
| Callus (AEC) | | |
| Regeneration of | RS-1 | 5-BrIAA 0.25 mg/l + Zeatin |
| Shoot (RS) | | riboside 8 mg/l + ABA 0.5 mg/l |
| | RS-2 | 5-BrIAA 1 mg/l + Zeatin riboside |
| | | 1 mg/l + BAP 1 mg/l + Kinetin |
| | | 1 mg/l + 2 iP1 mg/l + ABA 1 mg/l |

### EXAMPLE 2

### Preparation of a Plant Tissue Sample for Culture

Seeds of sweet corn (Zea mays) were obtained from USDA, Iowa. The accession of numbers are Ames 19325 for PA 91; Ames 15931 for H99 and PI 550473 for V924-6. The maize seeds were sterilized by first placing them in sterile water while gently stirring for 30 minutes. The seeds were then immersed in 95% alcohol for 1 min. The alcohol solution was removed and the seeds were placed into a side-arm-flask. A solution of 15% commercial bleach plus 0. 1% Tweene 20 (polyoxyethylene (20) sorbitan monolaurate) was prepared and added to the flask. A vacuum was applied to the seeds for 20 minutes while shaking. The vacuum was removed and shaking continued for an additional 25 minutes. The seeds were rinsed three times with sterile water in a clean hood. In some embodiments, the seeds may be soaked for another 5 days in sterile water at room temperature. In other embodiments, the seed may be soaked one day at room temperature and then incubated 4 days at 4° C. in sterile water.

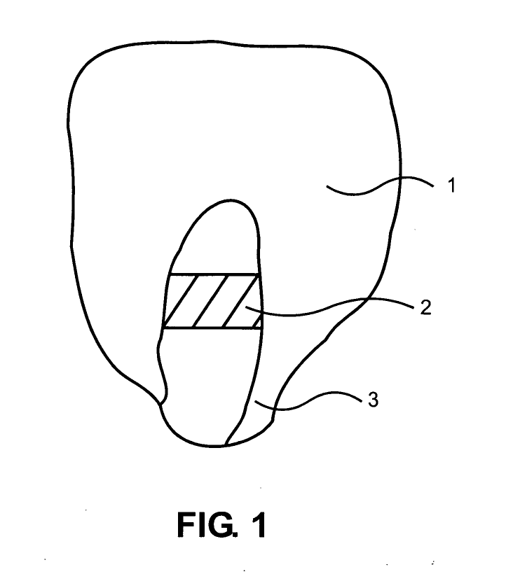

At this time, the embryos can be dissected from seeds under a dissecting microscope. The embryos may be cut into three sections (apical, middle and root) where the middle section has part of the apical and root sections as shown in FIG. 1.

### EXAMPLE 3

### Production of Embryogenic Calli from Tissue Samples

In preferred embodiments, the middle sections of a mature embryo derived from a seed may be placed onto the MS medium, which contains different growth regulator mixtures for stimulation of embryogenic callus formation. The middle section must be positioned with the root area touching the medium or on the side but never upside down. The sections are then incubated at 25° C. in the dark for six to eight weeks.

Various mixtures of growth regulators were tested for their ability to stimulate the formation of embryogenic calli. PA91 mature seeds (20-30 seeds) were surface sterilized, dissected and transferred onto MS medium with different plant growth regulator mixtures as described above. The results shown in Table 2 were obtained after incubation of the tissues in the dark at room temperature for two months.

TABLE 2

| | Plant growth regulator mixture | | | |
|---|---|---|---|---|
| | SECF-1 | SECF-2 | SECF-3 | SECF-4 |
| % of stimulation of | 12.5% | 10% | 10% | 7% |
| embryogenic callus formation | | | | |

In order to determine whether the stimulatory effect observed for SECF-1 would also be seen with other maize varieties, an number of different varieties were tested. Mature seeds (20-30 seeds) were surface sterilized, dissected and transferred onto N6+B5 vitamin medium with different plant growth regulator mixtures as described above. The results shown in Table 3 were obtained after incubation of the tissues in the dark at room temperature for two months. The numbers are the % of the tissue samples that formed embryogenic calli under the respective treatments.

TABLE 3
Plant growth regulator mixture

| | | 2,4D 1 mg/l + |
|---|---|---|
| Maize variety | SECF-1 | Dicamba 1 mg/l |
| PA91 | 12% | 0% |
| H99 | 6% | 0% |
| V924-6 | 7.5% | NA |

A comparison was made of the % of embryogenic calli formed as a function of the type of solidifying reagent and composition of the salt medium. PA91 mature seeds (20-30 seeds) were surface sterilized, dissected and transferred onto different medium with plant growth regulator mixtures SECF-3 as described. The membrane-based liquid culture was performed as follows: PA91 mature seeds (20-30 seeds) were surface sterilized, dissected and cultured on LifeRaft membranes in membrane-based liquid culture as described by Lin, et al., (FOCUS 17, 95, 1995). The results shown in Table 4 were obtained after incubation of the tissues in the dark at room temperature for two months.

TABLE 4

| | | % of embryogenic |
|---|---|---|
| | | callus formation using |
| Solidifying reagents | Medium | PA91 mature seeds |
| Gelrite | N6 salts + B5 vitamin | 19% |
| | MS salts | 10% |
| Agar | N6 salts + B5 vitamins | 10% |
| | MS salts | 25% |
| Membrane-based | MS salts | 24% |
| liquid culture | | |

The effect of temperature on embryogenic callus formation was investigated. After surface sterilization of maize seeds, PA91, as described above, the seeds were soaked in sterilized water for 5 days at room temperature. The embryogenic callus forming ability of these seeds was compared to seeds that had been soaked in sterile water for 4 days at 4° C. followed by one day at room temperature before dissection of embryos. The dissected embryos were transferred on to the N6 salts +B5 vitamin medium supplemented with the SECF-1 mixture and incubated in the dark at room temperature for two months. The results are presented in Table 5.

TABLE 5

| Temperature treatment | % of embryogenic |
|---|---|
| of maize seeds | callus formation |
| 5 days in room temperature | 11% |
| 4 days at 4° C. plus 1 day at | 35% |
| room temperature | |

In some embodiments it may be desirable to amplify the calli formed. After embryogenic callus formation, the callus may be transferred onto MS salt or N6 salt based medium with 2 mg 2,4-D for amplification of callus. The callus may be incubated in the dark at 25° C. for 1 month.

### EXAMPLE 4

### Regeneration of Shoots from Embryogenic Calli

Embryogenic calli prepared as described above may be transferred to a new shoot regeneration medium with different plant growth regulator mixtures. The embryogenic calli may be incubated in a cycle of 16 h light and 8 h dark at 25° C. for 2-3 weeks for shoot regeneration. The regenerated shoots may be transferred onto the MS medium free of plant growth regulator mixtures for further plant development. The effects of different plant growth regulator mixtures on the regeneration of shoots form embryogenic calli was investigated. Embryogenic calli prepared as described above were incubated in the presence of the shoot regeneration medium indicated and the results are presented in Table 6.

TABLE 6

| Type of regeneration | Number of amplified | % of shoot |
|---|---|---|
| medium | embryogenic calli | regeneration |
| RS-1 (see Table 1) | 16 | 100% |
| RS-2 (see Table 1) | 16 | 93% |

Having now fully described the present invention in some detail by way of illustration and example for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

All publications, patents and patent applications mentioned in this specification are indicative of the level of skill of those skilled in the art to which this invention pertains, and are herein incorporated by reference to the same extent as if each individual publication, patent or patent application was specifically and individually indicated to be incorporated by reference.

What is claimed is:

1. A plant growth affecting composition comprising an IAA derivative selected from a group consisting of mono-substituted IAA derivatives other than 5-Br-IAA, di-substituted IAA derivatives, multi-substituted IAA derivatives and mixtures thereof and further comprising at least one additional plant growth regulator, wherein said IAA derivative is in an amount and ratio to said additional plant growth regulator effective to increase plant growth.

2. The composition according to claim 1, wherein the IAA derivative is a mono-substituted IAA derivative other than 5-Br-IAA.

3. The composition according to claim 1, wherein the at least one additional plant growth regulator is selected from a group consisting of 2,4-D, BAP, ABA, zeatin riboside, kinetin, 2iP and dicamba.

4. The composition according to claim 1 further comprising a medium for culturing plant samples.

5. The composition according to claim 4, wherein the IAA derivative is a mono-substituted IAA derivative other than 5-Br-IAA.

6. The composition according to claim 4, wherein the at least one additional plant growth regulator is selected from a group consisting of 2,4-D, BAP, ABA, zeatin riboside, kinetin, 2iP and dicamba.

7. The composition of claim 1 wherein the ratio of said additional plant growth regulator to said IAA derivative is between about 50.0 and about 0.001.

8. The composition of claim 1 wherein the ratio of said additional plant growth regulator to said IAA derivative is between about 5.0 and about 0.05.

9. The composition of claim 1 wherein the ratio of said additional plant growth regulator to said IAA derivative is between about 2.0 and about 0.25.

10. The composition of claim 1 wherein the concentration of said IAA derivative is between about 1 μg/mL to about 100 mg/mL.

11. The composition of claim 1 wherein the concentration of said IAA derivative is between about 500 μg /mL to about 10 mg/mL.

12. The composition of claim 1 wherein the concentration of said IAA derivative is between about 1 mg/mL to about 5 mg/mL.

13. A plant growth affecting composition formed by mixing an IAA derivative selected from a group consisting of mono-substituted IAA derivatives other than 5-Br-IAA, di-substituted IAA derivatives, multi-substituted IAA derivatives and mixtures thereof with at least one additional plant growth regulator, wherein said IAA derivative is in an amount and ratio to said additional plant growth regulator effective to increase plant growth.

14. The composition according to claim 13, formed by mixing a mono-substituted IAA derivative other than 5-Br-IAA with at least one additional plant growth regulator.

15. A combination comprising a plant sample capable of forming an embryogenic callus and a kit for the production of an embryogenic callus from a plant sample, said kit comprising:
at least one container; and
a callus formation medium, wherein the callus formation medium comprises an IAA derivative selected from a group consisting of mono-substituted IAA derivatives, di-substituted IAA derivatives, multi-substituted IAA derivatives and mixtures thereof and further comprises one or more additional plant growth regulators.

16. The combination according to claim 15, wherein said kit comprises at least one container adapted for membrane-based liquid cell culture.

17. The combination according to claim 15 wherein said plant sample is a section of a mature plant embryo.

18. The combination of claim 17 wherein said section is the middle section of a plant embryo, said section having part of the apical and root sections.

19. The combination of claim 15 wherein said IAA derivative is 5-Br-IAA, and wherein said one or more additional plant growth regulators are selected from the group consisting of 2,4-D, BAP and ABA.

20. The combination of claim 15 wherein said IAA derivative is 5-Br-IAA, and wherein said one or more additional plant growth regulators are selected from the group consisting of zeatin riboside, BAP and ABA.

21. The combination of claim 15 wherein said IAA derivative is 5-Br-IAA, and wherein said one or more additional plant growth regulators are selected from the group consisting of 2,4-D, dicamba, BAP and ABA.

22. A kit for the production of an embryogenic callus from a plant sample comprising:
at least one container; and
a callus formation medium, wherein the callus formation medium comprises an IAA derivative selected from a group consisting of mono-substituted IAA derivatives other than 5-Br-IAA, di-substituted IAA derivatives, multi-substituted IAA derivatives and mixtures thereof and further comprises one or more additional plant growth regulators, wherein said IAA derivative is in an amount and ratio to said additional plant growth regulator effective to stimulate formation of an embryogenic callus.

23. A combination comprising a transgenic plant sample and a kit for the regeneration of a plant sample, said kit comprising:
at least one container; and
a regeneration medium, wherein the regeneration medium comprises an IAA derivative selected from a group consisting of mono-substituted IAA derivatives, di-substituted IAA derivatives, multi-substituted IAA derivatives, and mixtures thereof and further comprises one or more additional plant growth regulators.

24. The combination according to claim 23, wherein said kit comprises at least one container adapted for membrane-based liquid cell culture.

25. The combination according to claim 23 wherein IAA derivative is selected from a group consisting of mono-substituted IAA derivatives other than 5-Br-IAA.

26. The combination according to claim 23, wherein said kit further comprises a callus formation medium.

27. The combination according to claim 26 wherein said callus formation medium comprises an IAA derivative selected from the group consisting of mono-substituted IAA derivative, di-substituted IAA derivatives, multi-substituted IAA derivatives, and mixtures thereof and further comprises one or more additional plant growth regulators.

28. The combination of claim 27 wherein said IAA comprises 5-Br-IAA, and wherein said one or more additional plant growth factors are selected from the group consisting of zeatin riboside, BAP, kinetin, 2iP and ABA.

29. The combination of claim 28 wherein said one or more additional plant growth factors are selected from the group consisting of zeatin riboside, BAP and ABA.

30. The combination of claim 27 wherein the IAA derivative for both the callus formation medium and the regeneration medium is 5-Br-IAA.

31. The combination of claim 30 wherein said one or more additional plant growth regulators are selected from the group consisting of 2,4-D, BAP and ABA.

32. The combination of claim 30 wherein said one or more additional plant growth regulators are selected from the group consisting of zeatin riboside and ABA.

33. The kit of claim 27 further comprising a callus amplification medium which comprises 2,4-D.
